(19) United States
(12) Patent Application Publication
(10) Pub. No.: US 2002/0162083 A1
(43) Pub. Date: Oct. 31, 2002

(54) Mid-connect architecture with point-to-point connections for high speed data transfer

(75) Inventor: Michael L. Fowler, Saco, ME (US)

Correspondence Address: Patrick R. Scanlon, Esq., Pierce Atwood, One Monument Square, Portland, ME, 04101, US

(73) Assignee: Fairchild Semiconductor Corporation

(21) Appl. No.: 09/844,631

(22) Filed: Apr. 27, 2001

(51) Int. Cl. G06F 17/50

(52) U.S. Cl. 716/14

(57) ABSTRACT

A mid-connect interconnection system for coupling a plurality of function cards to one another via a plurality of switch cards. The connection may be established using direct connectors of very short length to provide high-speed transmission with little to no reflection concerns. The connectors are arranged such that the function cards are not connected in parallel with the switch cards. The mid-connect arrangement provides connector access points or locations corresponding in number to the number of switch cards multiplied by the number of line cards. The connectors are formed as one or more pairs of connectors, attached to the switch and function cards, to enable multi-channel point-to-point connections for full input and output among function cards. Each of the switch cards and each of the function cards includes a transceiver driver to enable high speed switching. The arrangement of cards provides broadband throughput on the order of Terabits per second.

### BACKGROUND OF THE INVENTION

1. Field of the Invention

The present invention relates to the physical layout of the communication interface architecture for an interconnect system. More particularly, the present invention relates to establishment of the connections among individual circuit boards or cards of a system. The cards may be used for internal signal exchange among boards of the system or for external signal exchange between other systems or system boards such as would be used in a computer or data transmission system, though this invention applies to the actual interconnect within the system. The present invention provides for improved signal exchange at high speed through unique card-interconnect architecture.

2. Description of the Prior Art

Standards have been established for the architecture of the hardware employed to enable the exchange of electrical signals among processing devices. The processing devices include integrated circuit systems built on and using printed circuit boards by an increasingly wide array of suppliers. The architecture standards ensure that the various devices will, in fact, be able to communicate with one another as well as with central processing units that control the operation of such peripheral devices. These peripherals include, but are not limited to, printer interfaces, video, audio, and graphics interfaces, memory, external communications interfaces, or any other sort of discrete device performing particular computer-related functions.

The circuit boards associated with the peripherals may be activated upon connection with a primary printed circuit board that establishes the physical interconnection of the central processing unit, power, memory structures, and the peripherals through an interconnection structure. The interconnection structure is a primary communication interface coupling device having connections to one or more slots or sockets in parallel into which circuit boards may be inserted. The slots include physical connectors and input/output interfaces to establish reception and transmission of signals among all devices coupled to the motherboard. It is the architecture of the interconnection structure that establishes the interface architectures required for the peripheral boards so that communication can occur between all peripherals and the central processing unit in an organized manner.

The interconnection structure is a printed circuit board or card used to enable the exchange of data as electrical signals among other boards or cards connected to it. The structure is typically identified as a backplane having the interconnection slots on one side thereof. The backplane establishes the physical signal exchange interconnection among connected cards. The interconnections are ordinarily established by way of metal wires known as traces. The traces are the physical connections over which electrical signals pass among the various cards associated with the data transmission system. The particular signaling technology running through the traces influences the rate of signal exchange and the number of traces interconnecting individual cards influences signal exchange bandwidth.

Simply stated, the circuit boards or cards that are connected to the backplane either transmit signals or receive signals. A card that is in a transmitting mode is described as a source card while one that is in receiving mode is described as a sink card. Apart from that most common set of attributes of a card that performs functions involving interaction with other cards, including a central processing unit, there are cards that operate solely to enable signal exchange. They are referred to as intermediate or switch cards in that they only relay signals between source and sink cards. On the other hand, a function card is designed to carry out specified applications. Finally, a line card is a function card that provides for signal exchange with the external world.

As might be expected, backplanes take on various forms to provide the particular functionality required. For example, an active backplane includes one or more active elements that provide some logic functionality. That is, they provide some filtering and routing of signals. A passive backplane, on the other hand, provides no such functionality but instead simply provides a physical medium through which signals are routed to and from all connected cards. While it provides no such filtering or routing capability, a passive backplane is important for system reliability in that all signals are permitted to pass through to each connected card, absent some sort of physical problem with a trace or traces.

As is well known in the art, a channel is a physical or optical pathway between the transmitters/receivers of individual cards and/or the central processor, memory, etc., of a data transmission system as well as external interfaces. Each channel is independent and can therefore transfer signals concurrently with other channels. In the field of signal exchange among multiple cards, there are key terms related to the data exchange channels. First, a multi-channel structure is one that includes multiple independent channels providing access from one or more cards to one or more cards. A multi-point channel is a single channel shared by a plurality of transmitting cards. A multi-drop channel, on the other hand, is one that is coupled to a single transmitting or source card but multiple receiving or sink cards. A point-to-point channel is one that has two and only two card connections.

The importance of the backplane architecture established by the channel arrangement to the field of signal exchange is evident. In particular, it is noteworthy that different systems require different signal exchange requirements and those requirements are dependent upon backplane channel layout. For example, in an equal access system, each card must transmit and receive a similar amount of information. Such systems include, but are not limited to, Local Area Network (LAN) switches, Wide Area Network (WAN) switches, and Redundant Array of Independent Disks (RAID). In a centralized access system, a single master card dominates access to the backplane and controls exchanges on the backplane. Such systems include, but are not limited to, personal computers. In a multiple access system, a plurality of cards require varying degrees of access to the backplane for transmission and reception as a function of time or particular application running. Such systems include, but are not limited to servers such as Internet Service Providers (ISPs).

In any of the systems described above, it is an important goal to provide a signal exchange system that enables signal exchange with little or no disruption. Increasingly, an important feature of the backplane is to provide for the transfer of greater quantities of signals (bandwidth) at faster propagation rates (high speed). Unfortunately, physical layout limitations and impedance concerns associated with the physical interconnections and signal drivers of many cards restricts high bandwidth, high speed signal transfer. Multi-channel, point-to-point or signal switch fabric interface (SSFI) backplane architecture has been recognized as a reasonable means to maximize signal bandwidth and propagation rates with high reliability. It is suitable for use in centralized and equal access environments. The SSFI backplane involves point-to-point connections enabling an increase in the number of cards connected to the backplane and greater channel access with a minimum number of backplane connections. However, the focus of high-speed signal change has been on internal switching, including through the use of midplane structures rather than backplane structures. There remains a need to increase the speed of data transmission in communications among external systems.

Therefore, what is needed is an interconnection structure that provides for high bandwidth, high-speed data transfer with little to no impact on signal integrity. Further, what is needed is such an interconnection structure that can be implemented using interface components substantially compatible with new and legacy circuit board interfaces. Yet further, what is needed is a high bandwidth, high speed interconnection structure suitable for deployment in the type of physical space generally available for computing systems. What is also needed is such an interconnection structure that makes efficient use of physical connectors or traces to reduce the impedances associated therewith. An additional need is to increase transmission rates for external signal exchange.

### SUMMARY OF THE INVENTION

It is an object of the present invention to provide an interconnection structure that provides for high bandwidth, high speed data transfer while minimizing impact on signal integrity. It is also an object of the present invention to provide an interconnection structure that can be implemented using interface components substantially compatible with new and legacy circuit board interfaces. In that regard, it is an object of the present invention to provide an interconnection structure without the need for a printed circuit board, such as a backplane or midplane, to connect the various cards. Further, it is an object of the present invention to provide a high bandwidth, high-speed interconnection structure suitable for deployment in the type of physical space generally available for computing and data transmission systems. Yet further, it is an object of the present invention to provide such an interconnection structure that makes efficient use of physical connectors and traces to reduce the impedances associated therewith.

These and other objects are achieved in the present invention, which is a mid-connect structure rather than a backplane or midplane structure. More specifically, the present invention is a mid-connect structure having on one side thereof a plurality of slots for line or function cards and on the other side a plurality of slots for, and a suitable number of, switch cards arranged at an angle other than parallel that will allow the switch cards on one side to attach to all of the line or function cards on the other side, typically this would be a perpendicular arrangement of the switch cards to the line or function cards. The switch cards provide a point-to-point switch fabric such that each connected line or function card has an indirect interface to all other line or function cards through the switch card in, what is typically described as a star topology. Further, in order to maximize throughput for certain system functions, each line or function card preferably includes a corresponding switch fabric to ensure direct input/output connections between each line or function card. In one example, for 21 line cards connected on one side of the mid-connect and 21 switch cards perpendicularly connected on the opposing side of the mid-connect, each with full duplex signaling at 2.5 Gigabits per second and a 21×21 switch on each line card, and each line card comprised of 21 2.5 Gigabits per second ports, it is possible to achieve, with the present invention, a full bandwidth data transfer of 21×21×2.5 Gigabits per second=2.205 Terabits per second non-blocked performance.

In order to enable the high bandwidth, high-speed signal exchange indicated using the mid-connect configuration described, it is important to provide as part of the present invention suitable signal transfer circuitry. Preferably, that signal transfer circuitry provides signal propagation substantially independent of particular signal exchange protocols. For that reason, each switch card includes, and each line or function card preferably includes, transceiver drivers suitable for high frequency propagation, including, for example, by Gunning Transceiver Logic Plus (GTLP), Low Voltage Differential Signal (LVDS), and Positive Emitter Coupled Logic (PECL) drivers. The switch drivers enable signal propagation among cards and to upstream interfaces, such as internal circuitry of a data transmission system including the mid-connect or for interfacing to external devices. For the purpose of this disclosure, line and function cards will be referred to as function cards.

Clearly, the designs of the two switch cards are important in the scheme of the present invention. The switch cards must be configured with processing logic necessary to ensure the proper transfer of signals among the various cards connected in the slots of the mid-connect. Preferably, the processing logic is configured to recognize all signal transmission protocols so that cards with differing protocols may interface with one another. Therefore, the mid-connect of the present invention is independent of signal protocols and is suitable as an exchange for legacy and future card protocols. The switch cards of the present invention therefore preferably employ SerDes and crosspoint switching configurations of the type well known in the art. Moreover, data packeting and arbitration logic are relatively simple to maximize reliable throughput.

These and other advantages of the present invention will become apparent upon review of the following detailed description, the accompanying drawings, and the appended claims.

### BRIEF DESCRIPTION OF THE DRAWINGS

FIG. 1 is a perspective view of the mid-connect layout of the present invention showing an exemplar set of 21 switch cards interconnected to 21 function cards.

FIG. 2 is a detailed perspective view of the connecting of an exemplar switch card to an exemplar function card.

FIG. 3 is front view of an exemplar switch card coupled to a plurality of function cards.

FIG. 4 is front view of an exemplar function card coupled to a plurality of switch cards in a first switch arrangement.

FIG. 5 is a front view of an exemplar function card coupled to a plurality of switch cards in a demultiplexer connection arrangement.

FIG. 6 is a detailed side view of an exemplar arrangement of the mid-connect structure.

FIG. 7 is a perspective view of a mid-connect layout of the present invention showing the mid-connect structure as a midplane structure.

### DESCRIPTION OF THE PREFERRED EMBODIMENT OF THE INVENTION

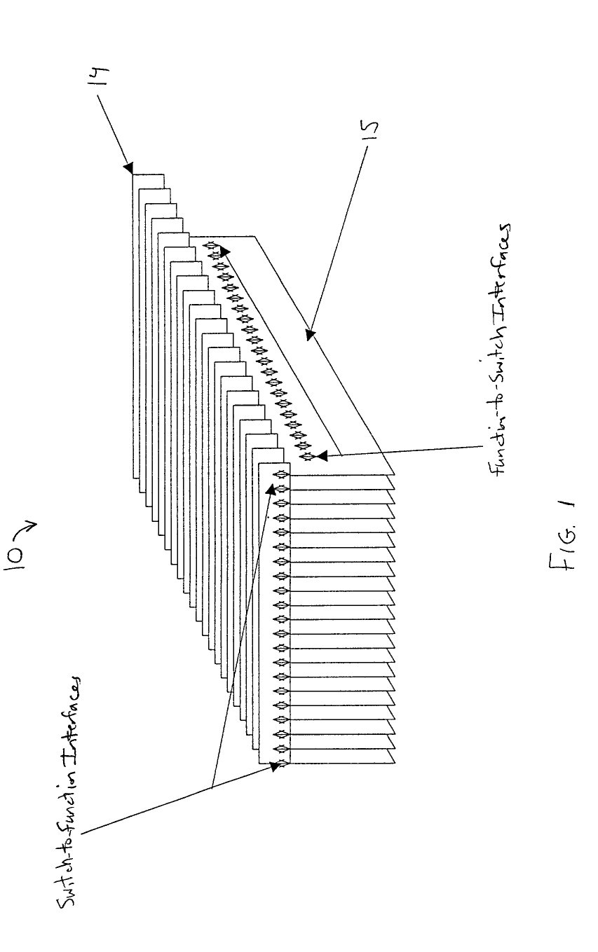

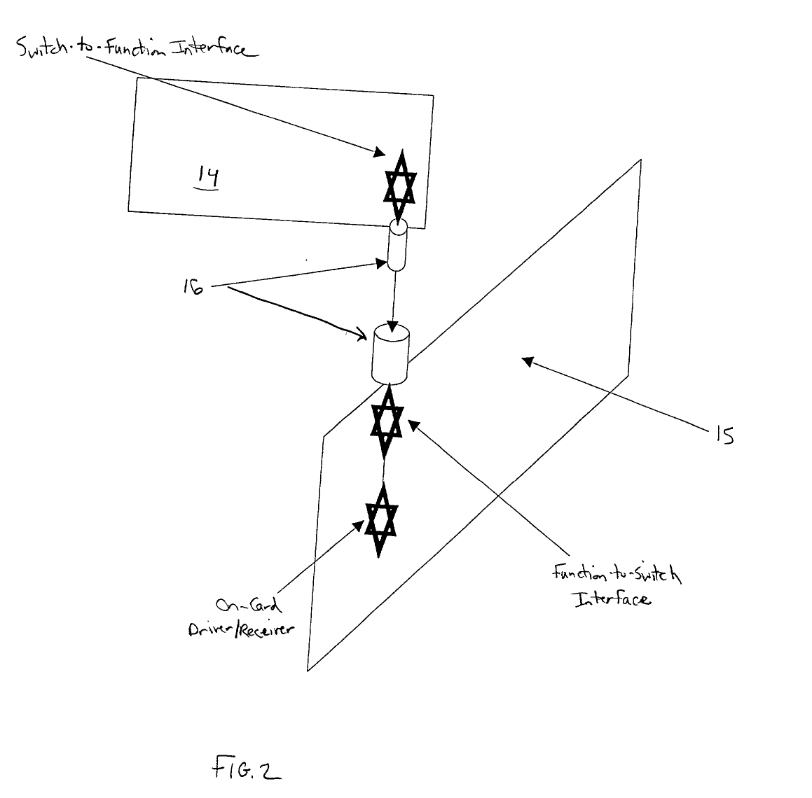

A mid-connect structure 10 of the present invention is shown in FIG. 1. It includes a plurality of switch cards 14 and a plurality of function cards 15 interconnected each directly to the other with a connector arrangement such as is shown in FIG. 2. Interface devices, such as drivers, receivers or full duplex driver/receivers are employed on each of the cards 14/15 to establish suitable electrical signal exchange.

As shown in FIG. 2, for maximum frequency performance, it is possible with this invention to place the drivers and receivers directly at the card side of the connector with minimal stub length on both sides of the single connector. Since there is only one connector and no traces between the driver and the receiver or, as in the case of FIG. 2 full duplex transceivers, it is minimal distance for the signal to traverse, reducing impedance and variances in impedance and the distance that the signal must travel, thereby maximizing the frequency performance of the signal. To continue the high performance capability on the card it is possible to either multiplex the signal at the driver or demultiplex the signal at the receiver. It is also possible to make a maximum frequency signal on the card since this is a point-to-point connection in a well controlled impedance environment of a printed circuit board with no connectors between the driver and receiver on the card causing unwanted changes in impedance.

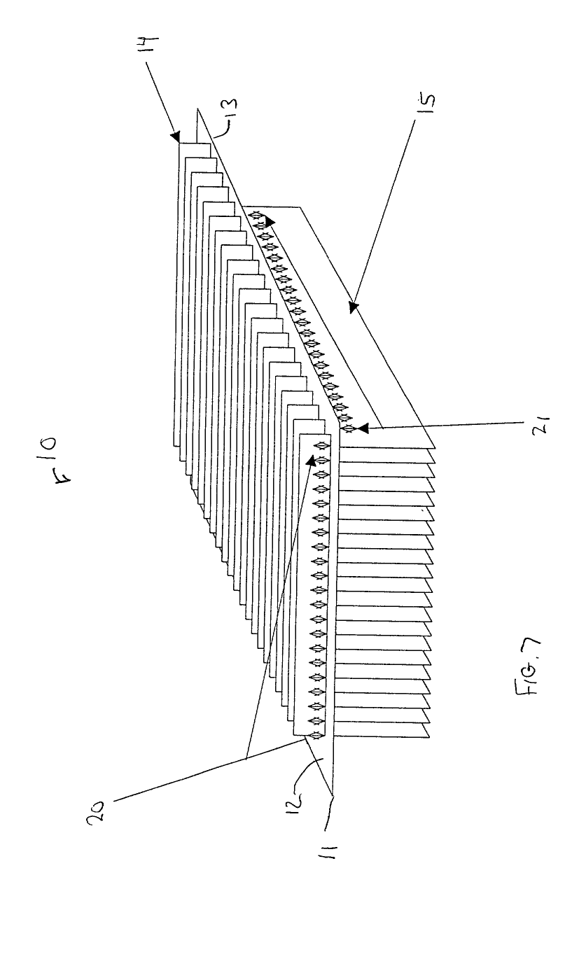

The mid-connect interconnection system 10 includes a plurality of through connectors 16 to establish the interconnection of the switch cards 14 to the function cards 15. In an example arrangement having 21 switch cards and 21 function cards, a 21×21 array of through connectors 16 is required. As shown in FIG. 6, the connectors 16 may be established as a set of pairs or sets of pairs of through connectors 16 formed of a female connector 16a and a male connector 16b. The female connector 16a includes a socket into which the male connector 16b fits. Those skilled in the art will readily recognize that such connectors may be deployed in the cards. Further, those skilled in the art will recognize that alternative means may be employed to establish short-length connections between the switch cards 14 and the function cards 15. Moreover, the present invention may be arranged so that the female connectors 16a are established on the switch cards 14 and the male connectors 16b are established on the function cards 15, or vice-versa.

The arrangement of sets of pairs of through connectors 16 is determined by the user as a function of throughput required, transceiver technology employed and layout space available. In the arrangement of the system 10 shown, the communication established is multi-channel, point-to-point with full duplex connections. However, any sort of communication form may be employed with the system 10 of the present invention including, but not limited to, unidirectional and bi-directional communications. Of course, two trace sets of through connectors 16 are required for bi-directional communication. Full duplex communication enables sourcing and sinking from or to each line or function card 15 via the switch cards 14. It doubles the performance parameters compared to unidirectional transmission. Alternatively, unidirectional operation halves the number of required trace sets as that of the bi-directional embodiment.

With continuing reference to FIG. 2, the extremely short connector pairs between the switch cards 14 and the function cards 15 provide the best means for fast signal transmission with minimal reflections and without the need for a backplane or a midplane structure. Drivers and/or receivers are preferably coupled to each of the connectors for optimum frequency transmission. Card cages are required to hold the cards stable, and a support structure should also be deployed between cards. Moreover, as shown, in the preferred design of the invention, each switch card 14 preferably has a driver/receiver set for each connector while each function card 15 includes similar discrete driver/receiver pairs at the connector edges with minimal stub length between the connector and the driver/receiver pair. Further, each function card 15 preferably also includes an on-card driver/receiver pair, such as for an ASIC or ASSP arrangement.

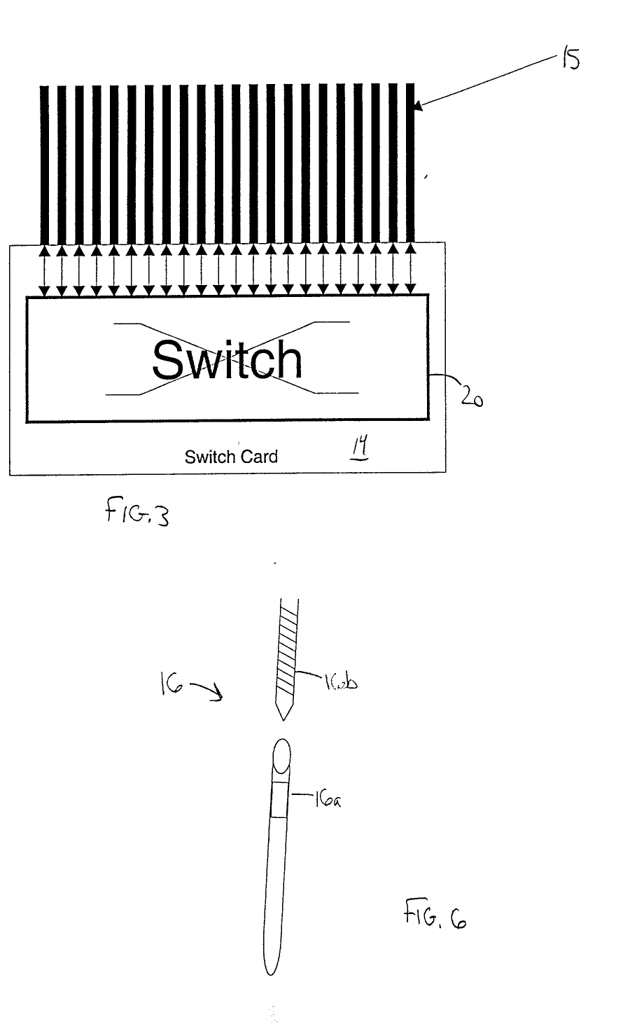

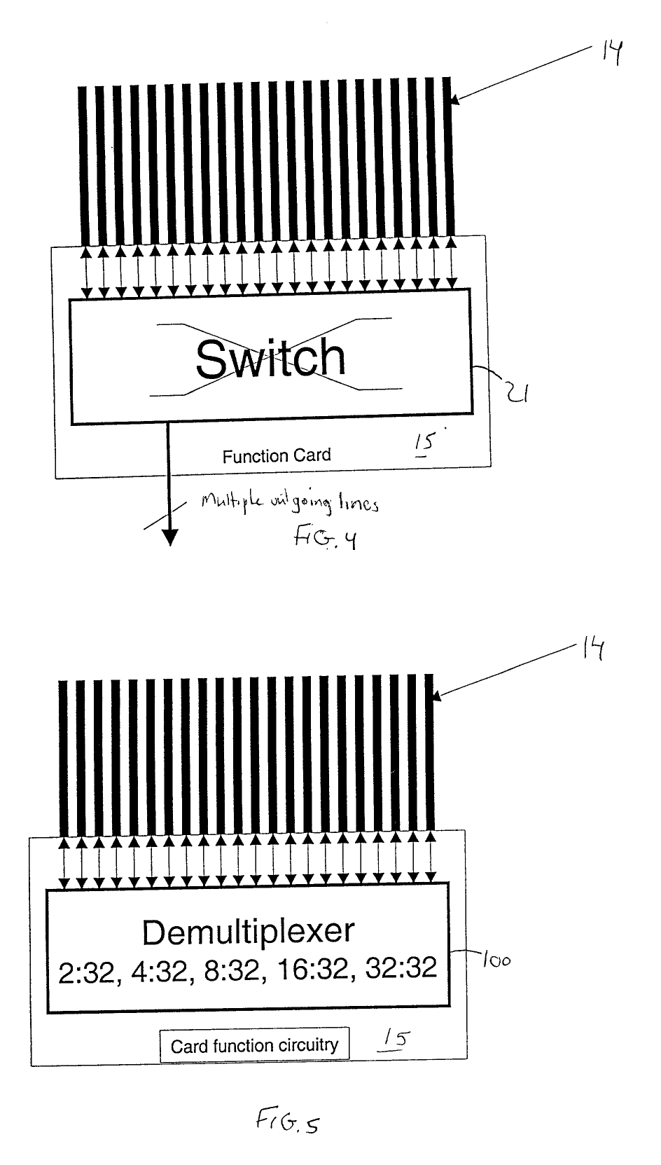

As illustrated in FIGS. 3 and 4, each switch card 14 includes a switch device 20 and each function card 15 may include a switch device 21. Alternatively, as shown in FIG. 5, a demultiplexer 100 may be employed on one or more of the function cards 15 to reduce the number of direct connections associated with the switch cards 14. Although each of the respective switch devices 20 and 21 may be selected by the user, provided it includes suitable input/output capability, switch devices are particularly well suited including, for example, the LVDS family of switches offered by Fairchild Semiconductor Corporation of South Portland, Me. Alternatively, Positive Emitter Coupled Logic (PECL) switch may be employed, particularly to maximize throughput. In the arrangement shown in FIG. 4, each function card 15 has the full bandwidth of X Gbps by Y switch connections available. In addition, resources can be located on the switch cards 14, if desired. Moreover, effective redundancy can be accomplished by deselecting a switch card 14 upon the failure of that single switch card 14. For the arrangement shown in FIG. 5, each function card 15 has the full bandwidth of X Gbps by Y switch connections available, while the demultiplexer allows for a lesser number of switch cards 14 to be connected and improving scaling performance.

In an alternative embodiment of the present invention shown in FIG. 7, the mid-connect interconnection system 10 of the present invention is established via a printed circuit board such as a midplane structure 11 that is preferably simply a card cage to support and align switch cards 14 on a first mid-connect side 12 and a second mid-connect side 13 to support and align function cards 15 in a connection manner well known to those skilled in the art. The through connectors, with the accurate alignment provided by a card cage, attached to the switch cards and function or line cards may each be unitary passing completely through the body of the structure 11 or they may be discrete elements on each of sides 12 and 13 but connected together. The connectors of FIG. 6 may be suitable for that purpose.

With continuing reference to FIG. 7, the midplane structure 11 is configured with a plurality of slots on each of sides 12 and 13 for receiving therein a selectable number of the switch cards 14 and a selectable number of the function cards 15, respectively. The slots of the structure 11 are arranged so that the switch cards 14 are perpendicularly oriented with respect to the function cards 15. In that way, the switching circuitry of respective switch cards are directly connected to all function cards 15 to effect a direct connection of each function card 15 to all other function cards 15 through the switch cards 14. The switch cards 14 include switch devices 20 and the function cards 15 include switch devices 21 to complete signal propagation interfaces among function cards 15.

The mid-connect system 10 of the present invention establishes a signal switching fabric interface that enables high bandwidth, high-speed throughput. It has a wide array of applications including, but not limited to, multi-processor servers, LAN and WAN routers and switches, and RAIDs. Further, the switch cards may be configured to manage any sort of signal propagation protocol including, but not limited to, Ethernet, Fibrechannel, Infiniband, and RapidIO, for example, each having its particular switch architecture. The point-to-point arrangement described permits the simplest form of data transmission to fit into the space available. That is, provided high-speed transceivers are employed such as is available through GTLP, LVDS, and PECL. This enables a system providing minimum distance between connections for a virtually unlimited number of switch cards and function cards, with a virtually unlimited number of channels.

It is contemplated that the system 10 of the present invention provides a convenient layout capable of handling channel speeds of the type associated with Ethernet, Infiniband, and Synchronous Optical Network (SONET/SDH), for example, and with substantially more cards than has heretofore been possible. In particular, 2.5 Gigabits per second (Gbps) transmission may be generated using the transceiver drivers identified. In the exemplar mid-connect arrangement shown in a full duplex mode, with 21 switch cards and 21 line cards, it is possible to provide a bandwidth on the order of 21×21×2×2.5 Gbps=2.205 Terabits per second. That sort of bandwidth is enabled in the present invention using an efficient connection layout in a board space of the type currently available and with transceiver drivers currently available.

Similar performance can be shown for a computer system, rather than a data transmission system, without the need for the switches on the function cards. In this case, to provide scalable performance, a variable number of input deserializers would be required on the function cards. In this way, the number of switches could be adjusted to the scaled performance requirements.

While the invention has been described with reference to particular example embodiments, it is intended to cover all modifications and equivalents within the scope of the following claims.

What is claimed is:

1. An interconnection system for electrically coupling together a plurality of function cards, the interconnection system comprising:
a. a plurality of function card mid-connect elements applied to each of the function cards; and
b. a plurality of switch cards in parallel with one another and having a plurality of switch card mid-connection elements applied thereto, wherein each of said plurality of switch cards includes a switch device for interconnecting each of said function cards to one another by connecting said function card mid-connect elements to corresponding ones of said switch card mid-connect elements,
wherein each set of said mid-connect elements are arranged such that when the function cards are connected to said plurality of switch cards, each function card is connected to all other function cards.

2. The interconnection system as claimed in claim 1 wherein the number of said plurality of switch cards is equal to the number of function cards.

3. The interconnection system as claimed in claim 1 wherein said function card mid-connect elements are male stub connectors and said switch card mid-connect elements are female stub connectors.

4. The interconnection system as claimed in claim 3 wherein said switch devices and said mid-connect elements are configured to enable full duplex signal propagation.

5. The interconnection system as claimed in claim 1 wherein said switch devices are transceiver switches.

6. The interconnection system as claimed in claim 5 wherein each of said transceiver switches establishes full duplex switching.

7. The interconnection system as claimed in claim 1 wherein each of said plurality of switch cards is oriented substantially perpendicular to the function cards.

8. The interconnection system as claimed in claim 1 wherein the function cards and said switch cards are coupled to one another through a printed circuit board.

9. The interconnection system as claimed in claim 8 wherein said printed circuit board is a midplane structure.

10. A process for establishing data transmission connections among a plurality of function cards, the process comprising the steps of:
a. establishing on each of the function cards a first plurality of connector elements;
b. providing one or more switch cards, each of said switch cards including a second plurality of connector elements for coupling to said first plurality of connector elements; and
c. joining said first plurality of connector elements to said second plurality of connector elements so that the function cards are aligned non-parallel with respect to said one or more switch cards so that each function card is connected to each other function card.

11. The process as claimed in claim 10 wherein the function cards are arranged substantially perpendicular to said one or more switch cards.

12. The process as claimed in claim 10 wherein said first plurality of connector elements and said second plurality of connector elements are connected to one another through a printed circuit board.

13. The process as claimed in claim 10 wherein the number of said switch cards corresponds to the number of function cards.

14. The process as claimed in claim 10 wherein said first plurality of connector elements are male connectors and said second plurality of connector elements are female connectors.
